(19) United States
(12) Patent Application Publication
(10) Pub. No.: US 2018/0213159 A1
(43) Pub. Date: Jul. 26, 2018

(54) INTELLIGENT CAMERA FOR ROBOTS

(71) Applicant: CHEN WEI ELECTRONICS CO., LTD., Taoyuan (TW)

(72) Inventor: Chia-Wen Wu, Hsinchu (TW)

(73) Assignee: CHEN WEI ELECTRONICS CO., LTD., Taoyuan (TW)

(21) Appl. No.: 15/643,532

(22) Filed: Jul. 7, 2017

(30) Foreign Application Priority Data
Jan. 25, 2017 (TW) 106201400
Jan. 25, 2017 (TW) 106201401
Jan. 25, 2017 (TW) 106201403
Jan. 25, 2017 (TW) 106201404

(51) Int. Cl. H04N 5/232; H04N 7/18; B25J 9/16

(52) U.S. Cl. CPC H04N 5/23296; H04N 7/183; Y10S 901/47; B25J 9/1697; H04N 5/23206

(57) ABSTRACT

A camera system for a robotic device includes a control circuit and at least one image capturing unit connected to the control circuit. The at least one image capturing unit generates an image signal. The camera system further includes a power source, a network connector for connecting to a network, and a pulse modulation input and output module. The pulse modulation input and output module includes a pulse modulation control circuit, a pulse modulation output port connected to the pulse modulation control circuit for outputting a pulse modulation signal to a controlled unit of the robotic device, and a pulse modulation input port connected to the pulse modulation control circuit for communicating the pulse modulation signal. The pulse modulation signal configures the control circuit and the controlled device of the robotic device.

### CROSS-REFERENCE OF RELATED APPLICATION

This is application claims priority based on Paris Convention to the following patent application filed before Taiwan Intellectual Property Office, Republic of China: Serial Numbers 106201400, 106201401, 106201403, and 106201404, all filed on Jan. 25, 2017. The entire disclosure of the above-referenced applications is incorporated by reference herein.

### BACKGROUND

Robotic devices have been in use in a variety of industrial, manufacturing, medical, computing, and research settings. These devices replace human involvements in areas such as repetitive tasks, tasks require high degrees of human physical strength and dexterity, etc. In certain disciplines, robotic devices are capable of performing the same tasks as human but with higher accuracy and efficiencies.

At the same time, robotic devices are also assisting humans with a variety of tasks, and some of these devices are required to detect or sense visually. Current approaches to add “visual” capabilities to a robotic device includes having one camera only—such as a standalone camera with connectivity—to capture images through the camera. This camera has a standalone input and output circuits that operate separately from the rest of the components. At the same time, the signals from the camera are also separate from the rest of the components of the robotic device.

### SUMMARY

Embodiments of this invention overcome deficiencies of the prior art by incorporating modulation signals to interact and communicate with the camera, just as with the rest of the components of robotic devices. In one embodiment, one of the pulse position modulation (PPM), pulse width modulation (PWM) or a pulse duration modulation (PDM) to communicate with the camera. In addition, aspects of the invention may incorporate multiple cameras for the robotic device as well as defining predefined or predetermined tracks for the robotic device to move from one location to another location.

### BRIEF DESCRIPTION OF THE DRAWINGS

The invention may be better understood by references to the detailed description when considered in connection with the accompanying drawings. The components in the figures may not necessarily be to scale, emphasis instead being placed upon illustrating the principles of the invention. In the figures, like reference numerals designate corresponding parts throughout the different views.

FIG. 1 is a diagram showing components of a camera for a robotic device according to one embodiment of the invention.

FIG. 2 is a diagram showing components of a camera separated from other components of a robotic device according to one embodiment of the invention.

FIG. 3 is a system diagram illustrating a system for remotely controlling of a robotic device according to one embodiment of the invention.

FIG. 4 is a system diagram illustrating another system for remotely controlling of a robotic device according to one embodiment of the invention.

FIG. 5 is a system diagram illustrating a further system for remotely controlling of a robotic device according to one embodiment of the invention.

FIG. 6 is a system diagram illustrating an alternative system for remotely controlling of a robotic device according to one embodiment of the invention.

FIG. 7 is a diagram of a camera of a robotic device according to one embodiment of the invention.

FIG. 8 is another diagram of the camera of a robotic device according to one embodiment of the invention.

FIG. 9 is a system diagram illustrating another system for remotely controlling of a robotic device according to one embodiment of the invention.

FIG. 10 is a system diagram illustrating a further system based on FIG. 8 for remotely controlling of a robotic device according to one embodiment of the invention.

FIGS. 11 and 12 are diagrams illustrating a multi-camera configuration for a robotic device according to one embodiment of the invention.

FIGS. 13 and 14 are system diagrams illustrating systems for remotely controlling a multi-camera configuration, similar to those of FIGS. 11 and 12, according to one embodiment of the invention.

Persons of ordinary skill in the art may appreciate that elements in the figures are illustrated for simplicity and clarity so not all connections and options have been shown to avoid obscuring the inventive aspects. For example, common but well-understood elements that are useful or necessary in a commercially feasible embodiment may often not be depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein may be defined with respect to their corresponding respective areas of inquiry and study except where specific meanings have otherwise been set forth herein.

### DETAILED DESCRIPTION

The present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

It is to be understood that analysts of all disciplines, either in a scientific field, social science studies, manufacturing, etc., constantly face with plethora of data to identify and process. Part of these analyses is to generate insights out of different datasets. There are many approaches, but one of the approach is to identifying correlations between datasets. In such an attempt, one may perform a join operation of two or more datasets stored in database storage or structures. The “join” operation may be part of database programming and such operation typically includes a syntax and a set of required parameters for a database oriented computer, such as a database server, to execute and generate results. When the datasets are small, the joining operation does not take very long, and the results are typically provided or generated instantaneously. However, as the size of the datasets starts growing exponentially, the join performance suffers significantly. This is because the join operation requires sorting and searching of the relevant data fields in the targeted datasets before producing an output dataset with the joined results.

Aspects of the invention provide a more approach to control and interact with robotic devices. Embodiments of the invention incorporate intelligent camera control signals into the control of the overall robotic device. In one example, instead of using the original or conventional control signals for the input/output circuits of a typical camera, one of the pulse position modulation (PPM) signal, pulse width modulation (PWM) signal, or a pulse duration modulation (PDM) signal replaces the original signals from the camera.

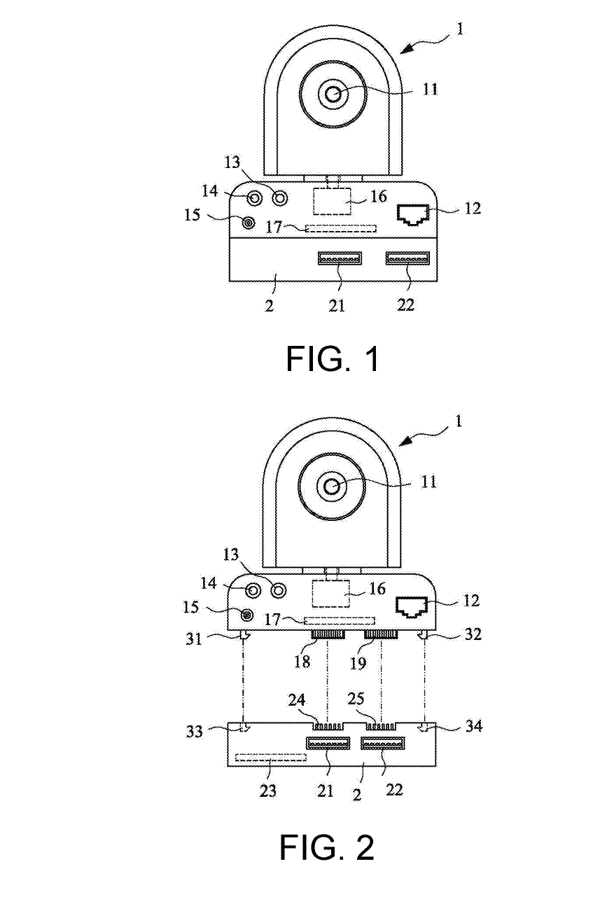

Referring now to FIG. 1, a diagram illustrates components of a camera 1 for a robotic device according to one embodiment of the invention. In one embodiment, the camera 1 may be a video camera or web camera capable of capturing images and video clips. In another embodiment, the camera 1 may be a digital camera embodied in another device, such as a mobile device, such that the controls of the digital camera may be modified according to aspects of the invention. The camera 1 may be connected to a robotic device. In one example, the robotic device (not shown) may include a robot with mobility components to move the robot from one location to another, a set of capturing components for receive, grab, hold, catch, grasp, possess, access, take, or otherwise obtain objects from another party, from another place, etc. In addition, the robot may also retrieve, take, deliver, or otherwise provide objects to another party or to another place. In another embodiment, the camera 1 includes an image or a video capturing unit 11, a network connectivity unit 12, an audio output port 13, an audio input port 14, an a power source 15. In one embodiment, the image or video capturing unit 11 may capture images or video (e.g., motion pictures). It is to be understood that the video capturing unit 11 may include different image capturing parts, such as lenses, etc. It is to be understood that the number of lenses, the placements of the lenses may vary, but these modifications or variations would not affect the teaching of embodiments of the invention. In another embodiment, the camera 1 includes a data storage unit for storing, on a permanent basis or a temporary basis, images or videos captured by the image or video capturing unit 11.

Still referring to FIG. 1, the network connectivity unit 12 connects the camera to a computer network, such as the Internet. In one embodiment, the network connectivity unit 12 may be a wired or wireless network device or module for negotiating network protocols, such as TCP/IP, between the camera 1 and another network device. In such an example, the network connectivity unit 12 may assign or may receive an assignment of a network address or an internet protocol address for the camera 1. In a further embodiment, the audio output port 13 and the audio input port 14 may be incorporated as one unit or as separate units, such as the ones shown in FIG. 1. The audio output port 13 may output audio signals therefrom and the audio input port 14 may receive audio signals thereto. For example, via the network connectivity unit 12, the audio output port 13 may provide audio signals to another device connected thereto, such as a speaker (not shown) to produce audible signals to human ears. In another embodiment, the audio output port 13 or the audio input port 14 may be connected via wired means (as shown in FIG. 1 with outlets) or wireless means, such as Bluetooth or Wi-Fi.

In a further embodiment, the camera 1 may include a motor 16 for moving positions or directions of the camera 1. For example, the motor 16 may rotate, tilt, spin, etc., the camera 1 to adjust or dispose the position thereof for capturing images or videos. In another embodiment, the motor 16 may further include motion stabilizing components for maintain stability of the camera 1 during its movement between positions such as to maintain the quality of the images or videos. Also, the camera 1 may include a control circuit or unit 17. In one embodiment, the control circuit or unit 17 may control the camera 1 based on instructions received from a user or a sensor.

Aspects of the invention differ from prior art approaches by removing the typical control circuit signals for the camera. Instead of the signals that are used to solely controlling the different aspects of the camera, such as on/off switches, still-image/video capturing switches, audio on/off switches, zoom-in/out switches, etc., embodiments of the invention incorporate modulation signals that are used for controlling parts of the robotic device such that the control circuit or unit 17 may perform more complex operations for controlling the camera 1 while controlling the different parts of the robotic device. In one embodiment, the control circuit or unit 17 may be incorporated or connected to an input/output module 2. In another embodiment, the input/output module 2 may include a pulse modulation output port 21, a pulse modulation input port 22, and a pulse modulation control 23. In one example, the pulse modulation output 21 may be connected to the pulse modulation control 23 such as that the pulse modulation control 23 may output or control a component or device of the camera or the robotic device provided from the pulse modulation output port 21. Similarly, the pulse modulation input port 22 may be connected to the pulse modulation control 23 such that the pulse modulation control 23 may control inputs provided from the pulse modulation input port 22.

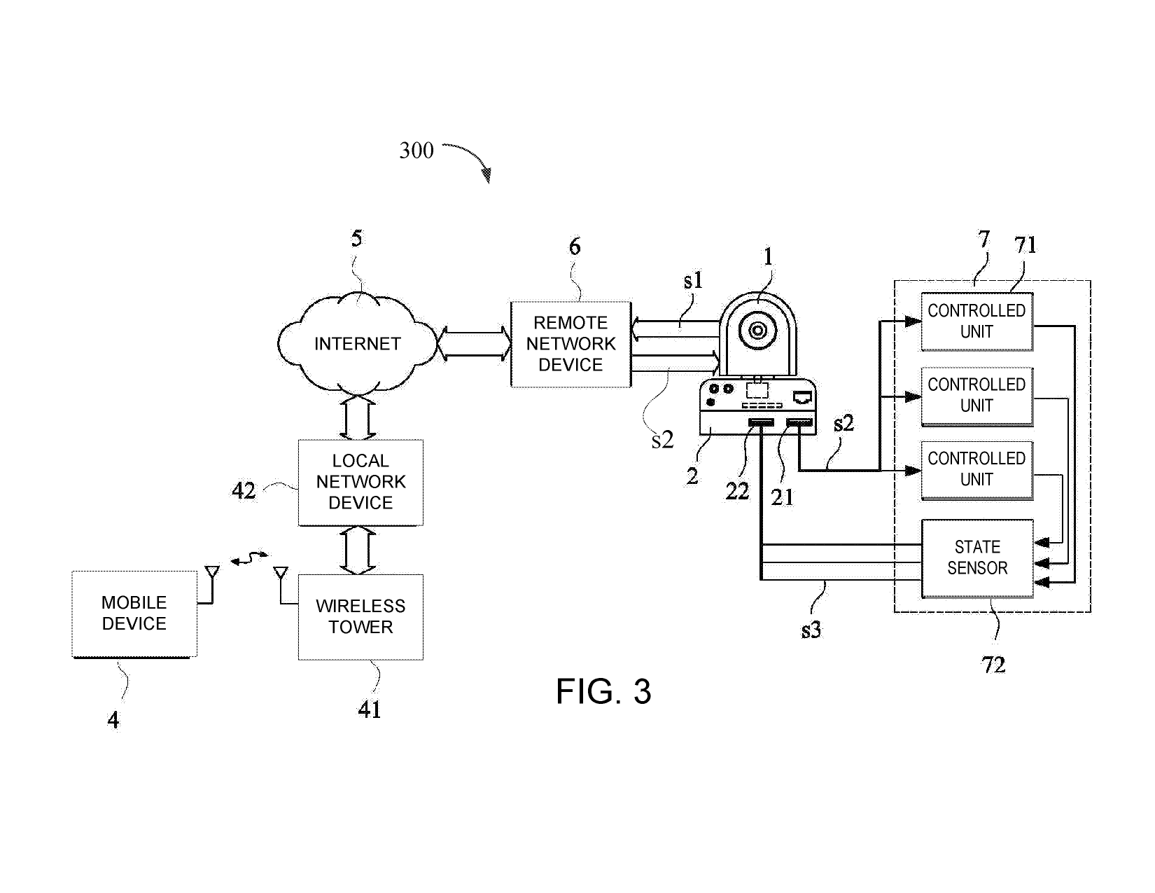

Referring now to FIG. 2, a diagram illustrates components of a camera separated from other components of a robotic device according to one embodiment of the invention. In particular, FIG. 2 illustrates one example of the input/output module 2 may be connected to the camera 1. As illustrated, the camera 1 includes connectors 18 and 19 for connecting corresponding connectors 24 and 25 of the input/output module 2. In one embodiment, the connectors 18 and 19 are further connected to control circuit or unit 17 such that the pulse modulation output port 21, the pulse modulation input port 22, and the pulse modulation control 23 of the input/output module 2 may be connected to the control circuit or unit 17. As shown in FIG. 2, the connectors 18, 19, 24, and 25 are embodied in physical connectors. As such, securing members 31, 32, 33, and 34 may be used to further secure these connectors 18, 19, 24, and 25. In one example, the securing members 31, 32, 33, and 34 may be made of plastic and may be a set pin lock combinations. In another embodiment, the securing members 31, 32, 33, and 34 may be a combination of nuts and bolts. It is to be understood that other types of securing members may be used without departing from the scope and spirit of embodiments of the invention.

It is to be understood that the connectors 18, 19, 24 and 25 may be incorporated in the same module such that the connectivity is seamless and that the connection speed is greatly enhanced. In a further embodiment, the connectors 18, 19, 24 and 25 may be wireless in nature. In such an embodiment, the connectors may be of a certain bandwidth, protocol, encryption, signal strength, etc., such that the connectivity is properly maintained to ensure the connectivity between the camera 1 and the input/output module 2. It is also to be understood that anti-disturbance measures may be employed to minimize disturbances between electrical components and parts.

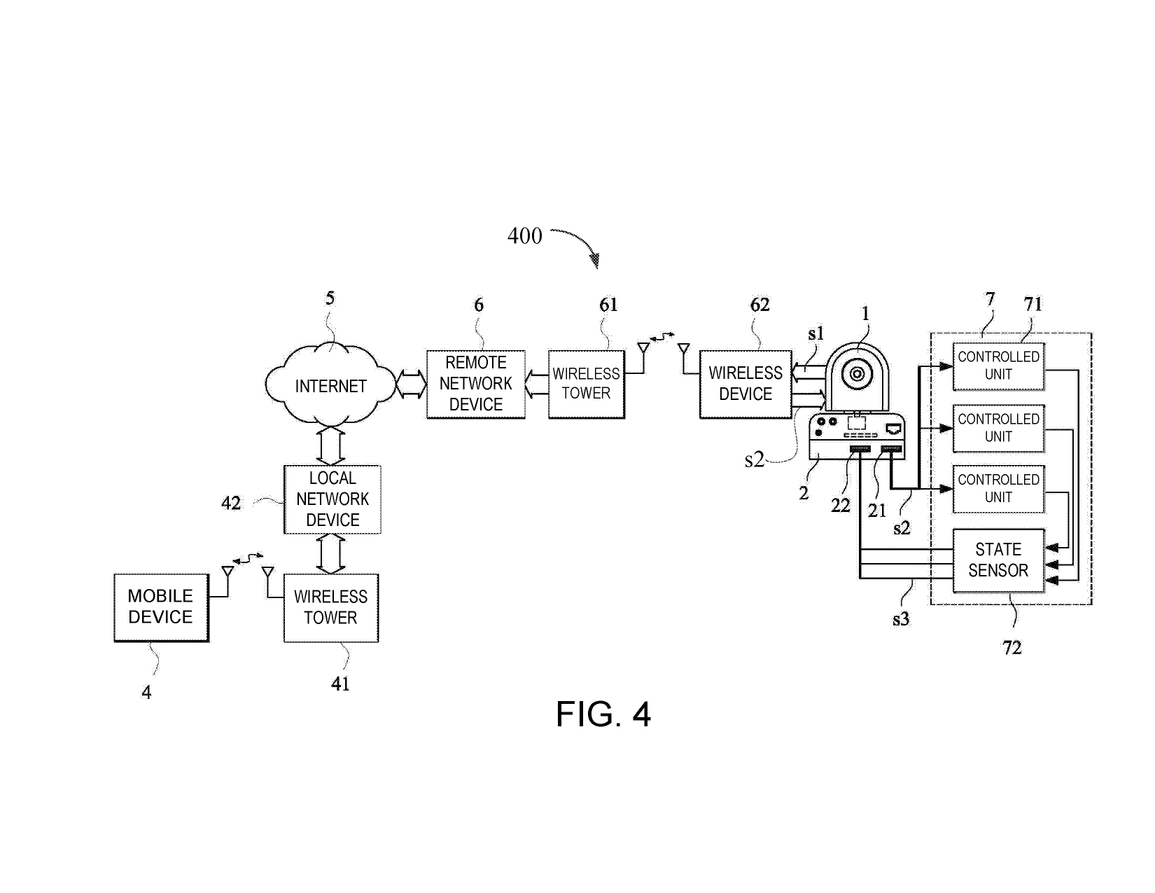

Referring now to FIG. 3, a system diagram illustrates a system 300 remotely controlling of a camera or a robotic device according to one embodiment of the invention. In this embodiment, a user (not shown) may use a mobile device 4 in one location via a wireless tower 41, a local network device 42, the Internet 5, and a remote network device 6 to be connected with the camera 1 at another location different from the location of the mobile device 4. In this example, the captured images or video in digital format may be transmitted through s1 via the remote network device 6, the Internet 5, the local network device 42, and the wireless tower 41 to the mobile device 4. In response, the mobile device 4 may transmit at least one pulse modulation signal via s2 via the wireless tower 41, the local network device 42, the Internet 5, and the remote network device 6 to the pulse modulation input port 22 of the input/output module 2. Upon receiving such input, the pulse modulation output port 21 of the input/output module 2 may next transmit the pulse modulation signal to at least one controlled unit 71 of a controlled device 7. In one embodiment, the controlled device 7 may be the robot or the robotic device. In another embodiment, the at least one controlled unit 71 may be a component or part of the controlled device 7.

In one example, the mobile device 4, such as a portable device, a smartphone with telecommunication and networking capabilities may be connected to the wireless tower 4 via a Wi-Fi connection. In a further embodiment, the mobile device 4 may be digital communication device or a wearable electronic device. In another example, the local network device 42 may be connected to the wireless tower 4 via a wired connection. It is to be understood that the mobile device 4 may be connected to the wireless tower 4 with a wired connection or that the local network device 42 may be connected to the wireless tower 4 via a wireless connection without departing from the scope or spirit of the embodiments of the invention.

Still referring to FIG. 3, the controlled device further may include a state sensor 72. In this embodiment, the state sensor 72 may monitor or detect a state of the at least one controlled unit 71. In one example, the state sensor 72 may sense, detect, or monitor state signal s3 relating to, for example: angle of rotation, state of vibration, distance traveled, speed of rotation, acceleration, height information, elevation information, distance information, etc. The signal s3 may be transmitted to the camera 1 via the pulse modulation input port 22 before the signal s3 being transmitted via the remote network device 6, the Internet 5, the local network device 42, and the wireless tower 41 to the mobile device 4.

In one example, the signal s2 may be one of the PPM, PWM or PDM. Correspondingly, the controlled device 7, as well as the camera 1, may receive one of the PPM, PWM or PDM signals such that the controlled device 7 may be controlled. For example, the controlled device 7 may be a remote controlled car, a wireless drone flying device, a motor, an illuminating device, or an audio device.

Referring now to FIG. 4, another system diagram illustrates a system 400 remotely controlling of a camera or a robotic device according to one embodiment of the invention. The system 400 includes a wireless tower 61 connected to the remote network device 6. The camera 1, in this embodiment, includes a wireless device 62. As such, the camera 1 in the system 400 may be connected to the Internet 5 via the wireless device 62, the wireless tower 61 and the remote network device 6.

In the example where the robotic device 7 has a robotic arm or limb as a controlled unit 71, the camera 1 may be positioned or disposed near the robotic arm or limb. As such, it is to be understood that the camera 1 may be disposed or positioned at various positions and the different locations where the camera 1 is positioned relative to the controlled unit 71 do not depart from the scope or spirit of embodiments of the invention.

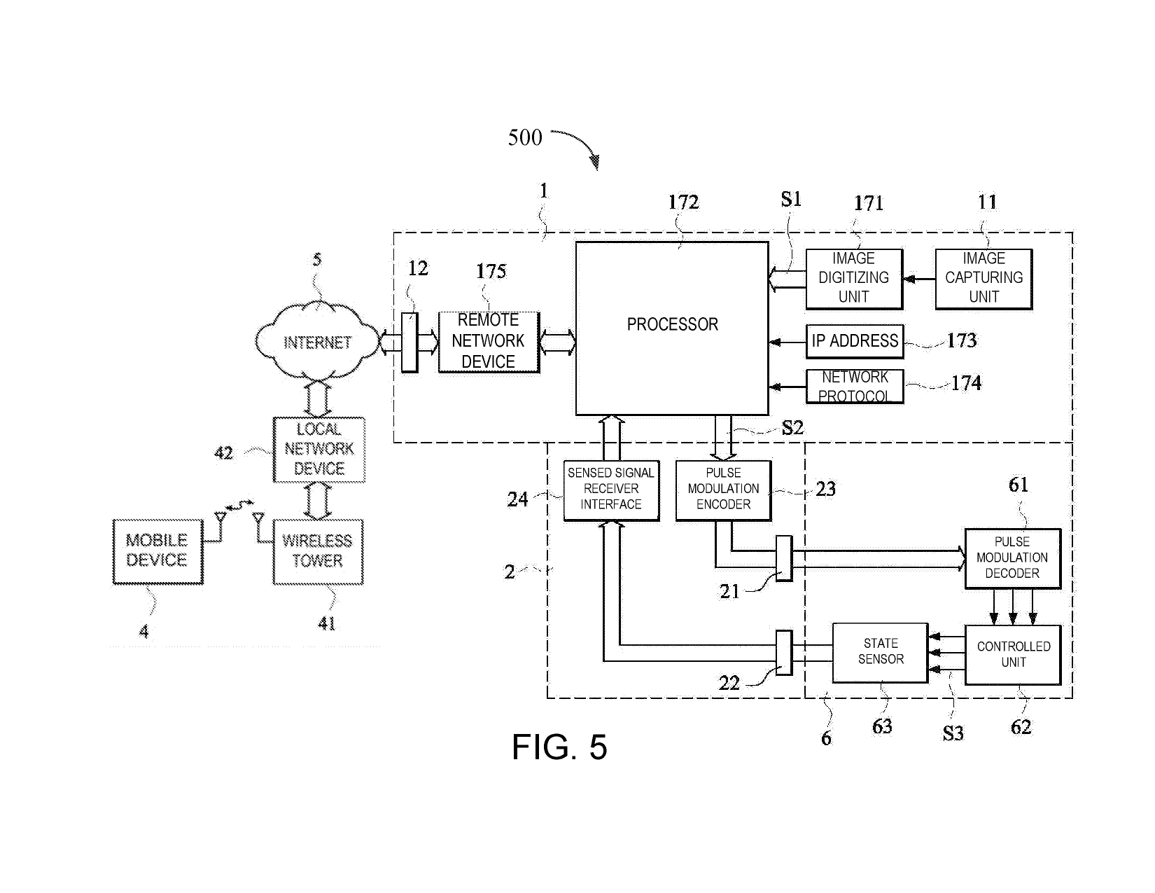

Referring now to FIG. 5, a system diagram illustrates a system 500 for remotely controlling of a robotic device according to one embodiment of the invention. In one embodiment, the system 500 provides further embodiment of the camera 1. For example, the camera 1 may include an image capturing unit 11 for capturing, for example, images and videos. After the images or videos are captured, they are converted to digital data or information s1 where a processor 172 and an image digitizing unit 172 are to receive the digital data s1. The processor 172 may include network capabilities such as an internet address 173 and a network protocol 174 for configuring the internet address 173. A remote network device 175 may be connected to the processor 172 for connecting to the Internet 5 via a network port 12.

The input/output module 2 may include a pulse modulation encoder 23 and a sensed signal receiver interface 24. The pulse modulation encoder 23 and the sensed signal receiver interface 24 may be connected to the processor 172 of the camera 1.

In one example, the mobile device 4 may connect through the wireless tower 41, the local network device 4, the Internet 5, and the remote network device 175 to the camera 1. Via the connection, the digital data s1 may be transmitted to the mobile device 4 or the mobile device 4 may receive the digital data s1 from the camera 1. In addition, the mobile device 4 may transmit at least one pulse modulation signal s2 to the input/output module 2. The pulse modulation encoder 23 may encode the pulse modulation signal s2 before the encoded signal is transmitted to a pulse modulation decoder 61 of a controlled device 6. The decoded signal may then control at least one of controlled unit 61 of the controlled device 6.

The controlled device 6 may also include a state sensor 63 for detecting signals s3 of the controlled unit 63. In one example, the state sensor 63 may sense, detect, or monitor state signal s3 relating to, for example: angle of rotation, state of vibration, distance traveled, speed of rotation, acceleration, height information, elevation information, distance information, etc. The signal s3 may be transmitted to the camera 1 via the pulse modulation input port 22 and the sensed signal receiver interface 24 before the signal s3 being transmitted to the processor 172 of the camera 1 via the remote network device 175, the Internet 5, the local network device 42, and the wireless tower 41 to the mobile device 4.

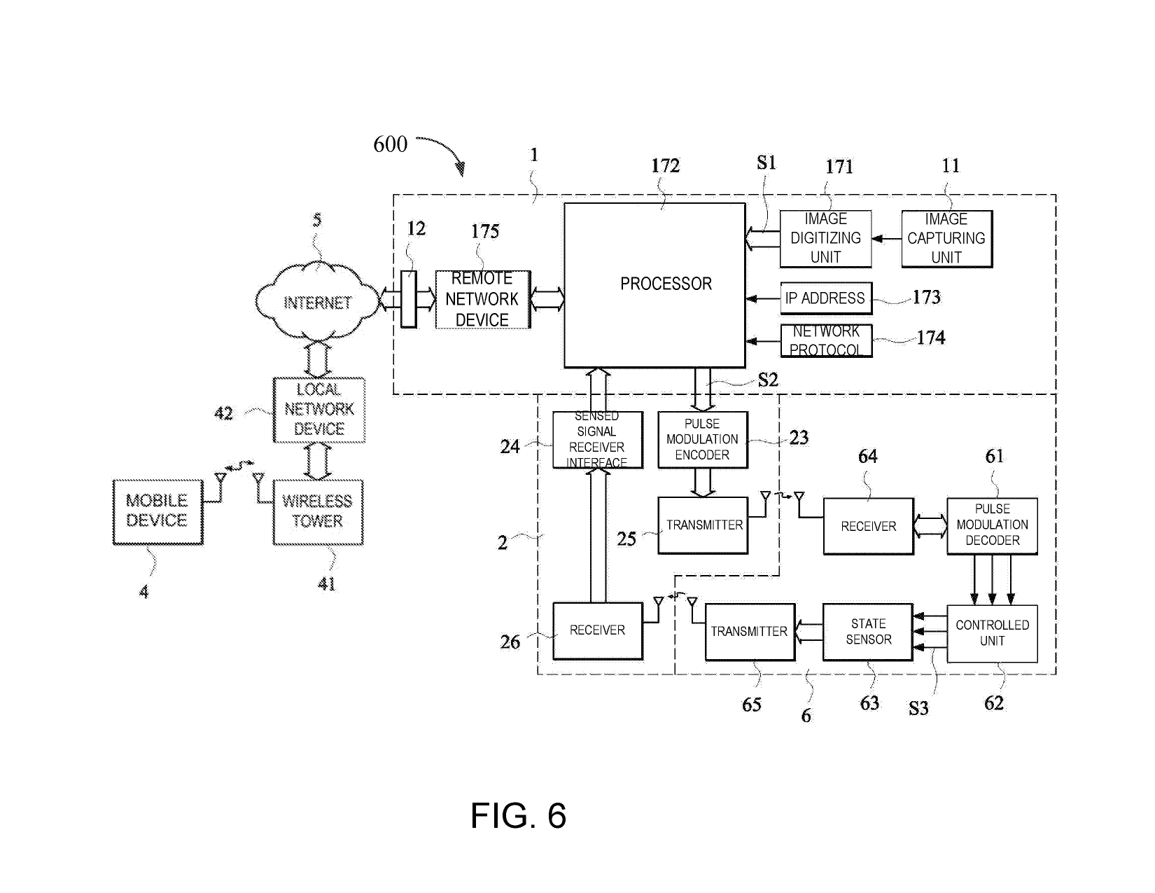

Referring now to FIG. 6, a system diagram illustrates a further system 600 for remotely controlling of a robotic device according to one embodiment of the invention. In this embodiment, the system 600 may include a transmitter 25 in the input/output module 2, and the transmitter 25 may be connected to the pulse modulation encoder 23. Correspondingly, the controlled device 6 may include a corresponding receiver 64. The signal s2 may be transmitted via the transmitter 25 via wired or wireless means to the receiver 64 of the controlled device 6. The encoded signal then is transmitted to the pulse modulation decoder 61 for controlling at the least one controlled unit 62 of the controlled device 6.

Still referring to FIG. 6, the system 600 may also include a receiver 26 in the input/output module 2, and the receiver 26 is connected to the sensed signal receiver interface 24. The controlled device 6 may also include a corresponding transmitter 65 for transmitting, wired or wirelessly, the signal s3 to the receiver 26 of the input/output module 2 before transmitting it to the sensed signal receiver interface 24.

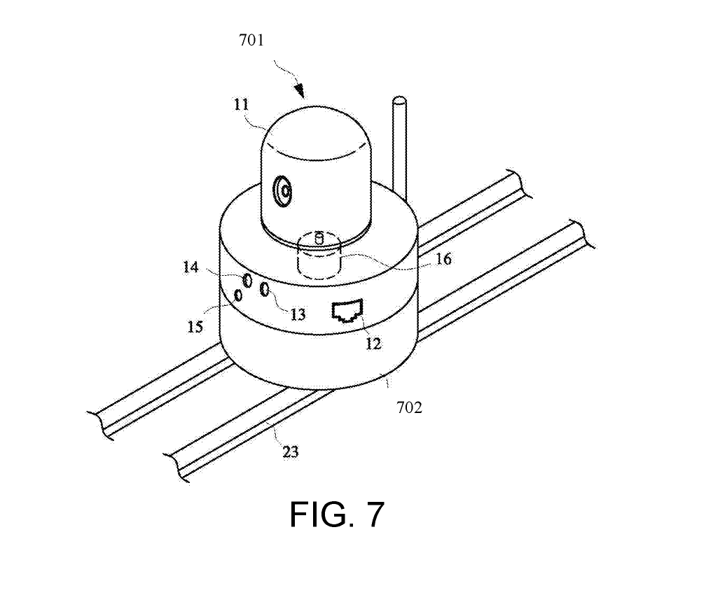

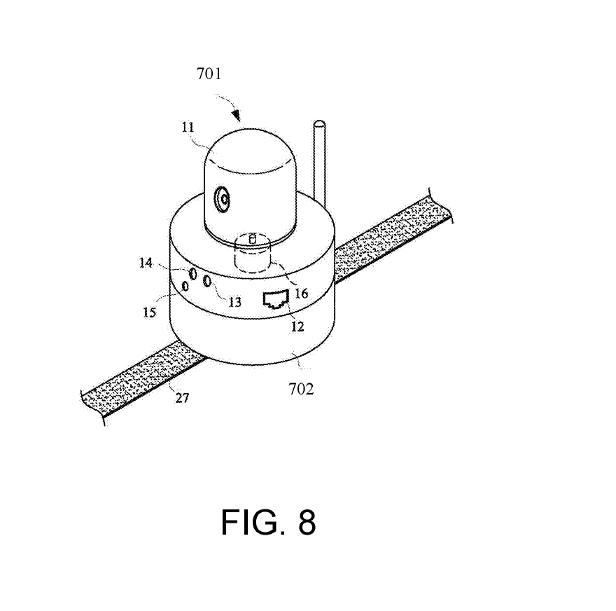

Referring now to FIG. 7, another diagram of the camera 701 of a robotic device according to one embodiment of the invention. In this embodiment, the camera 701 includes a motion module 702 for moving the camera 701 to different positions. For example, the motion module 702 may include a motor 21 and a motion device 22, such as wheels. Once the motion module 702 is activated, the motion device 22 may be moved along a guide 23. In one embodiment, the guide 23 may be set along a predefined space, such as a factory, a house, an office space, a game parlor, a stage, a cleaning area, an exterior wall of a building, a cable car track, etc. The motor 21 may cause the motion device 22 to move along the guide 23 and only along the guide 23. In one embodiment, the guide 23 may include a track, a set of cables or ropes, a set of rails, etc. In a further embodiment, the guide 23 may set as straight lines or may include curves or angled turns. In another embodiment as shown in FIG. 8, a guide 27 may be used. In this embodiment, the guide 27 may be motion-sensing activated to guide the motion module 702.

In one embodiment, the motion module 702 may be connected to the camera 701 as an integrated unit or may be connected to the camera 701 as a separate unit through connectors, etc.

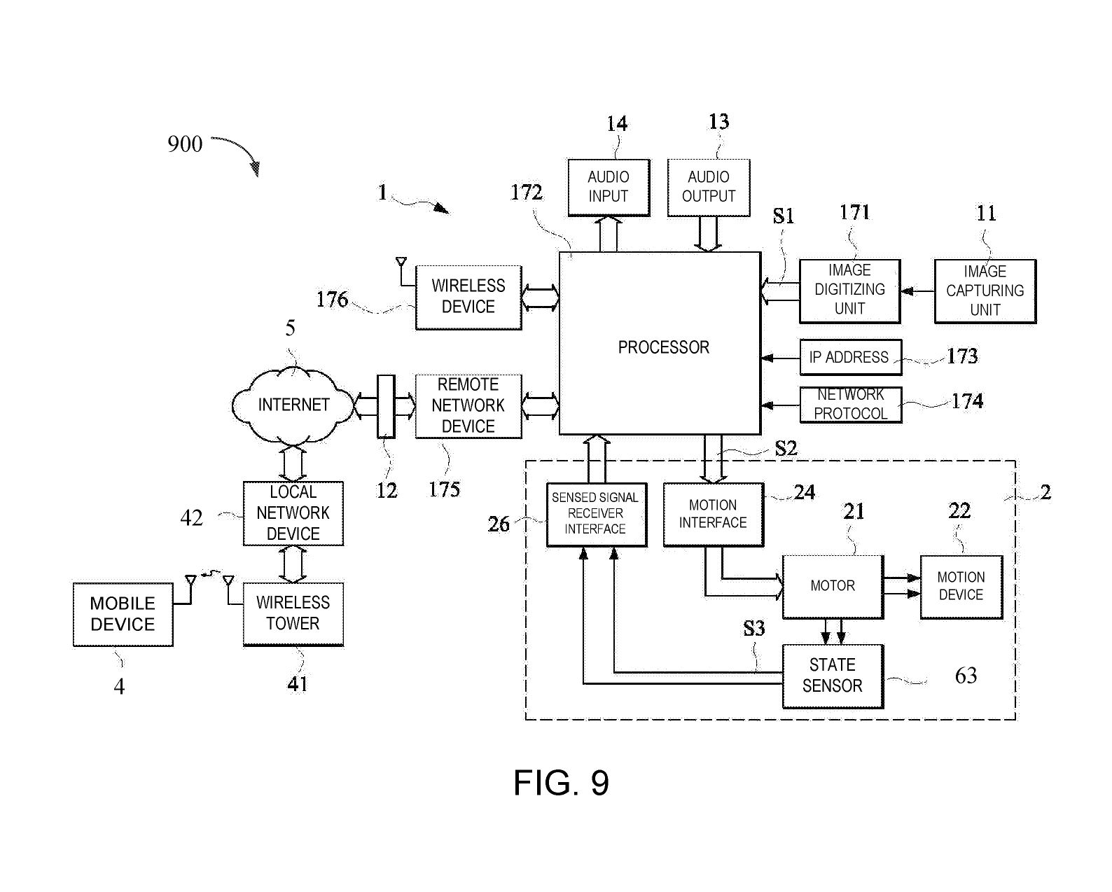

Referring now to FIG. 9, a system diagram illustrates a system 900 of a camera according to one embodiment of the invention. In this embodiment, similar to the system 600, while the camera 1 is moving via the motor 21, the image capturing unit 11 captures images or videos for the camera 1 continuously. At the same time, the state sensor 25, during the relocating of the camera 1, senses or detects the signal s3 from the camera 1 and the motor 21. For example, the signal s3 includes data such as location of the camera 1, the speed of the motor 21, etc.). The signal s3 is then transmitted to the processor 172 of the camera 1 via the sensed signal receiver interface 26. The signal s3 may be next transmitted to the mobile device 4 via the remote network device 175, the Internet 5, the local network device 42 and the wireless tower 41.

In one embodiment, the motor 21 receives a control signal, in addition to rotate or move the motion device 22 to create the movement for the motor 21, to move the camera 1 along the guide 23. The motor 21 may also lead the camera 1 away from the guide 23. The motion device 22 may move the camera 1 to expand the range of the camera 1.

It is to be understood that while the control signal may be transmitted or sent from the processor 172, the mobile device 4 may also send the control signal to the processor 172 via the wireless tower 42, the local network device 41, the internet 5, the remote network device 175 and the wireless network device 176.

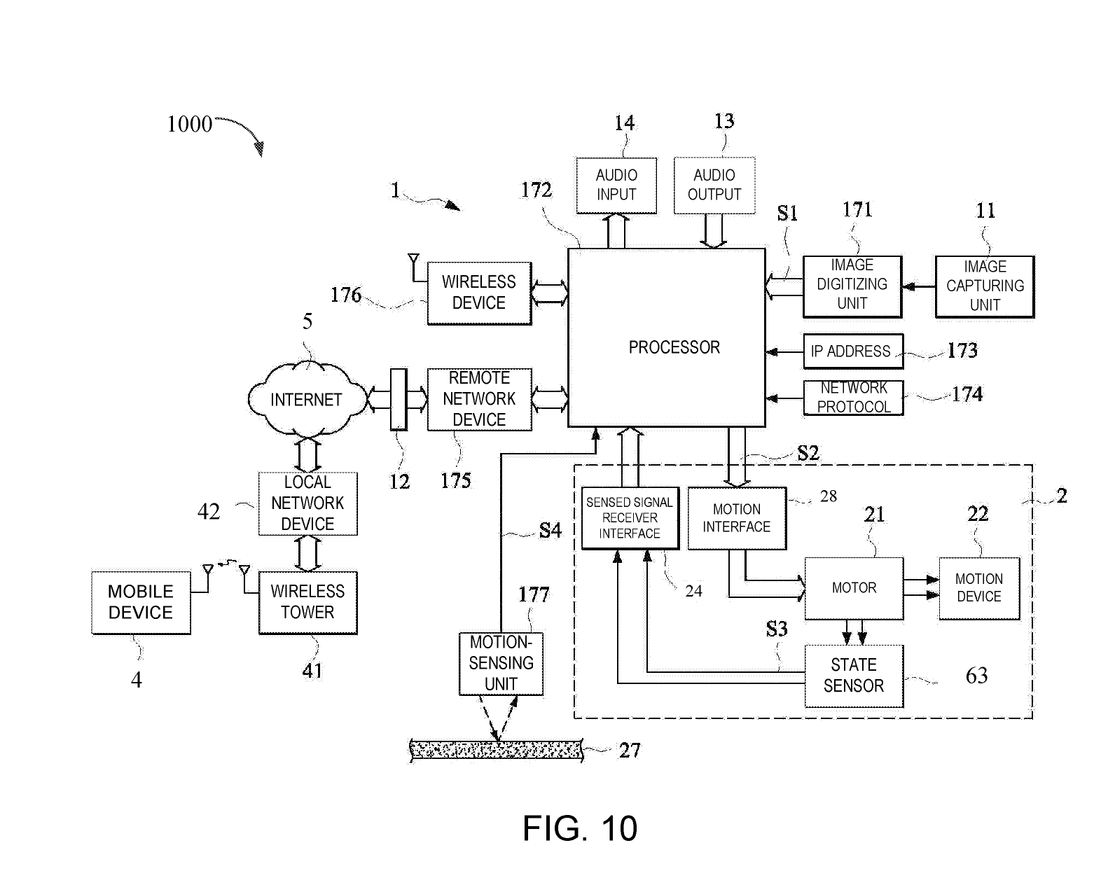

FIG. 10 is a further system diagram illustrating system 1000 according to another embodiment of the invention. This embodiment may be more suitable to configure according to the camera 701 according to FIG. 8. The motion-sensitive guide 27 may be disposed along a guide track on a surface as a reflective paint or a metallic paint. A motion-sensing unit 177 of the processor 172 may be a unit for detecting or sensing reflective materials or magnetic materials. The motion-sensing unit 177 may also send a track signal s4 to the processor 172. As such, through the control of the processor 172, the camera 701 may be moved along the guide 27 in addition to moving the motor 21 and the motion device 22.

According to another embodiment, the guide 27 may be of magnetic materials or of colored bar coded or coded tapes. As such, the motion-sensing unit 177 may read the guide 27. In one embodiment, the user may then be able to know the direction of the camera 701. When the camera 701 is off the guide 27, the user may also identify that through the camera 701.

In one embodiment, the camera 1 or camera 701 may include multiple camera lenses. For example, the camera 1 or 701 may include multiple image capturing units for capturing units and, based on previous discussions, the image data may be encoded via pulse modulations.

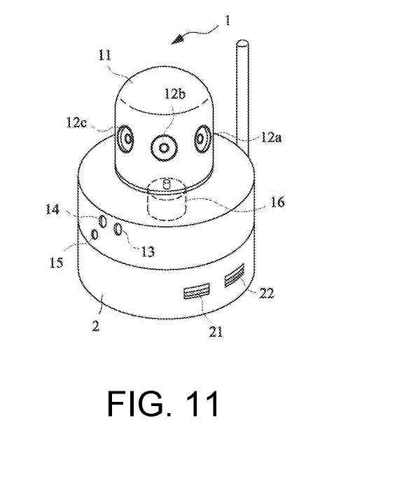

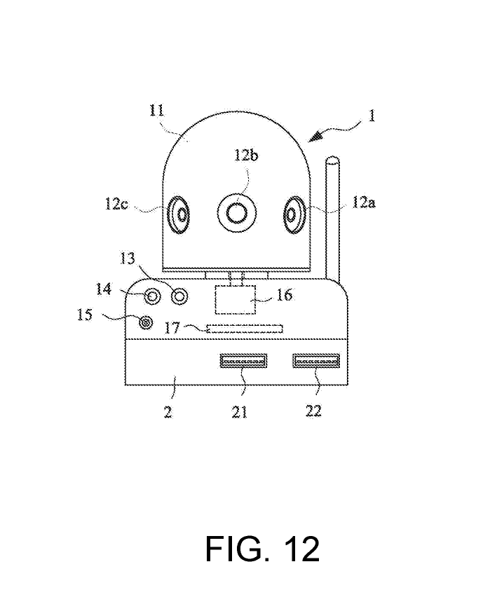

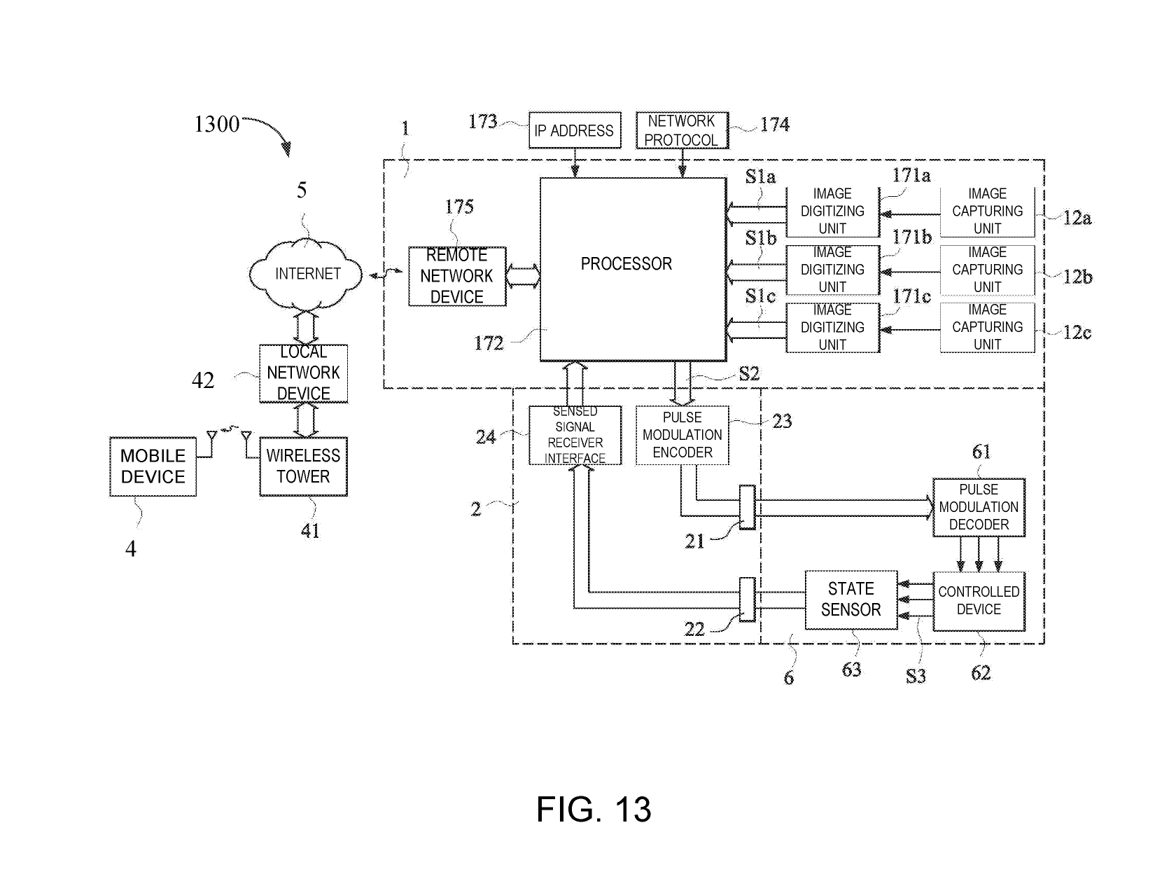

Referring now to FIGS. 11 and 12, the two diagrams illustrate a multi-camera configuration for a robotic device according to one embodiment of the invention. In these illustrations, FIG. 11 shows a perspective view while FIG. 12 illustrates a front view of the diagram. The camera 1 may include a body 11 and one or more image capturing units 12a, 12b, and 12c. The camera 1 may also include the audio output port 13, the audio input port 14, and the power source 15. In one example, the image capturing units 12a, 12b, and 12c may individually capture two or more images. The audio output port 13 and the audio input port 14 may provide the respective signals.

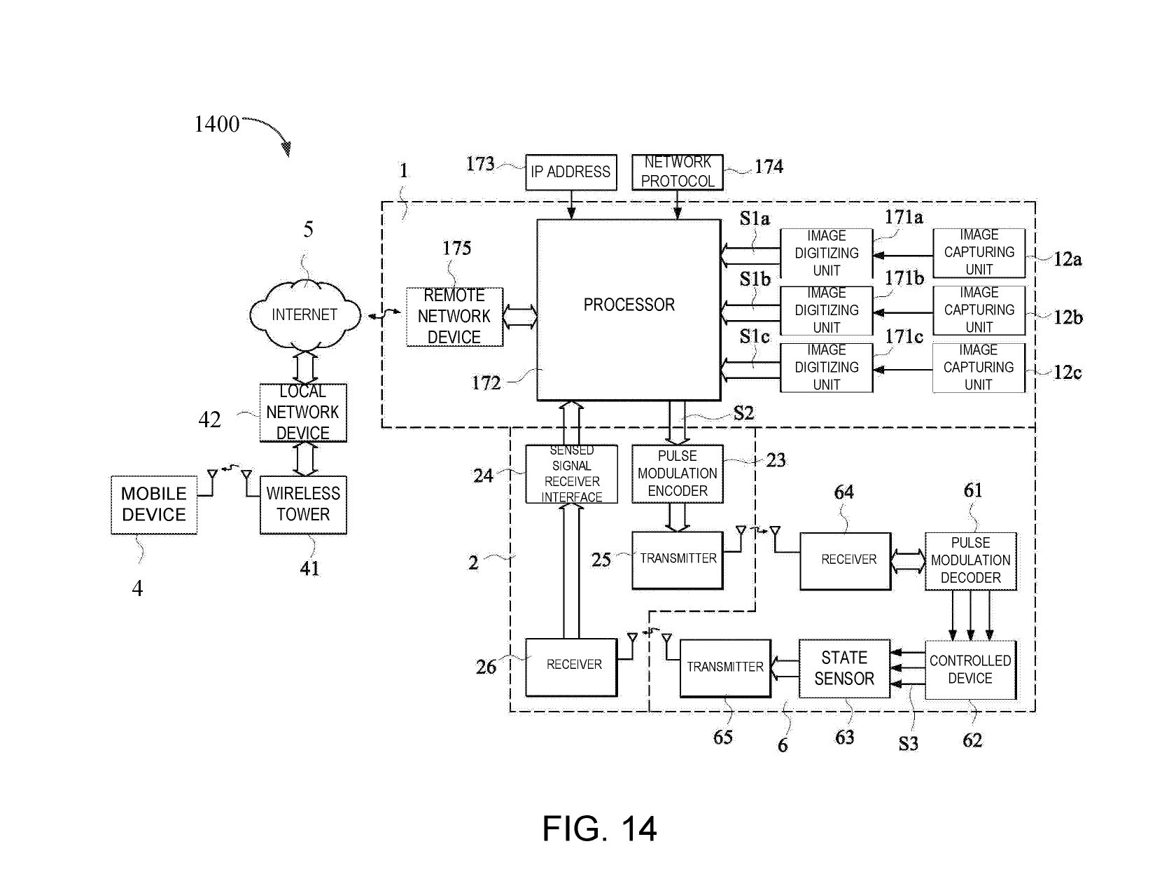

Referring to FIGS. 13 and 14, two system diagrams illustrate systems (system 1300 and system 1400) for remotely controlling a multi-camera configuration, similar to those of FIGS. 11 and 12, according to one embodiment of the invention. In one embodiment, once the one or more image capturing units 12a, 12b, and 12c capture one or more images, image digitizing units 171a, 171 b, and 171c may individually or separately receive the images from the one or more image capturing units 12a, 12b, and 12c. Once received, the image digitizing units 171a, 171 b, and 171c digitize the images and create image data s1a, s1b, and s1c. The processor 172, being connected to the 171a, 171 b, and 171c, may receive the image data s1a, s1b, and s1c.

Similar to examples illustrated above, the mobile device 4 may receive the image data s1a, s1b, and s1c and may send at least one pulse modulation signal s2 to the input/output module 2. With the different image capturing units 12a, 12b, and 12c, the controlled unit 62 may separately be paired to one of the image capturing unit.

In operation, the camera 1 or 701 may be implemented in a robotic device or a robot for assisting humans in a number of different capacities. Once such setting may be in an assisted living setting where the robot installed with the camera 1 or 701 is used to assist elders or individuals (hereinafter “users”) with physical disability. In this setting, the camera 1 or 701 may capture the surroundings of the living space for the users and provide the images to the individuals and/or doctors, caregivers, family members, etc. The users may control the robot through the images captures via a mobile device or other controls to configure or control different controlled units of the robot and the camera 1 or 701 using signals with pulse modulation characteristics. This, as explained previously, has the advantages over the prior practices because prior approaches use different types of signal characteristics to control the cameras and parts of the robots.

The robots may be used to open doors. In one example, in the embodiments with multiple cameras, one such camera may be installed near the limb or arm of the robot. In this configuration, the robotic arm or limb may be able to aim the door handle more directly and accurately.

The robots may also be used to retrieve medicines or healthcare products for the users. In this example, the camera 1 or 701 may be functions such as zoom in and zoom out to identify labels. In another example, where the labels may include bar codes or other QR codes, the processor 172 may be configured to identify or interpret the contents embedded in the bar codes or QR codes.

It is further to be understood that other uses or capabilities may be incorporated into embodiments of the invention without departing from the scope and spirit of the invention. For example, the camera 1 or 701 may include infrared capabilities such that the users may use the camera 1 or 701 to capture infrared images.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving data payload execution systems. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

What is claimed is:

1. A camera system for a robotic device comprising:
a control circuit;
at least one image capturing unit connected to the control circuit, said at least one image capturing unit generating an image signal;
a power source;
a network connector for connecting to a network;
a pulse modulation input and output module, said pulse modulation input and output module including:
a pulse modulation control circuit;
a pulse modulation output port connected to the pulse modulation control circuit for outputting a pulse modulation signal to a controlled unit of the robotic device;
a pulse modulation input port connected to the pulse modulation control circuit for transmitting the pulse modulation signal; and
wherein the pulse modulation signal configures the control circuit and the controlled unit of the robotic device.

2. The camera system according to claim 1, wherein the pulse modulation signal includes at least one of the following signal: a pulse position modulation (PPM) signal, a pulse width modulation (PWM) signal or a pulse duration modulation (PDM) signal.

3. The camera system according to claim 1, further comprising a motor.

4. The camera system according to claim 1, further comprising a state sensor for detecting a signal representing a state of the controlled unit.

5. The camera system according to claim 4, wherein the signal comprises at least one of the following: angle of rotation, state of vibration, distance traveled, speed of rotation, acceleration, height information, elevation information, distance information, etc.

6. The camera system according to claim 4, wherein the state sensor is configured to transmit the signal via the pulse modulation input port.

7. A camera system for a robotic device comprising:
a control circuit;
at least one image capturing unit connected to the control circuit, said at least one image capturing unit generating an image signal;
a power source;
a network connector for connecting to a network;
a pulse modulation input and output module, said pulse modulation input and output module including:
a pulse modulation control circuit;
a pulse modulation output port connected to the pulse modulation control circuit for outputting a pulse modulation signal to a controlled unit of the robotic device;
a pulse modulation input port connected to the pulse modulation control circuit for communicating the pulse modulation signal; and
wherein the pulse modulation signal configures the control circuit and the controlled unit of the robotic device.

8. The camera system according to claim 7, wherein the pulse modulation signal includes at least one of the following signal: a pulse position modulation (PPM) signal, a pulse width modulation (PWM) signal or a pulse duration modulation (PDM) signal.

9. The camera system according to claim 7, further comprising a motor for adjusting a position.

10. The camera system according to claim 7, further comprising a state sensor for detecting a signal representing a state of the controlled unit.

11. The camera system according to claim 10, wherein the signal comprises at least one of the following: angle of rotation, state of vibration, distance traveled, speed of rotation, acceleration, height information, elevation information, distance information, etc.

12. The camera system according to claim 10, wherein the state sensor is configured to transmit the signal via the pulse modulation input port.

13. The camera system according to claim 7, further comprising a second motor for adjusting a position of the robotic device.

14. The camera system according to claim 13, further comprising a guide for guiding the second motor.

15. The camera system according to claim 14, wherein the second motor is configured in response to the image signal.

16. A camera system for a robotic device comprising:
a control circuit;
at least one image capturing unit connected to the control circuit, said at least one image capturing unit generating an image signal;
a power source;
a network connector for connecting to a network;
a pulse modulation input and output module, said pulse modulation input and output module including:
a pulse modulation control circuit;
a pulse modulation output port connected to the pulse modulation control circuit for outputting a pulse modulation signal to a controlled unit of the robotic device;
a pulse modulation input port connected to the pulse modulation control circuit for communicating the pulse modulation signal; and
wherein the pulse modulation signal configures the control circuit and the controlled unit of the robotic device.

17. The camera system according to claim 16, wherein the at least one image capturing unit is disposed in different locations of the robotic device.

18. The camera system according to claim 17, wherein one of the different locations include a limb of the robotic device.

19. The camera system according to claim 16, further comprising a mobile device for transmitting a signal to the control circuit in response to the image signal received at the mobile device.

20. The camera system according to claim 16, further comprising a pulse modulation encoder and a pulse modulation decoder.
